(19) United States
(12) Patent Application Publication
(10) Pub. No.: US 2011/0261782 A1
(43) Pub. Date: Oct. 27, 2011

(54) RADIO COMMUNICATION SYSTEM, RADIO BASE STATION, AND THRESHOLD SETTING METHOD

(75) Inventors: Shinji Nakano, Yokohama-shi (JP); Masamitsu Nishikido, Yokohama-shi (JP)

(73) Assignee: KYOCERA CORPORATION, KYOTO-SHI, KYOTO (JP)

(21) Appl. No.: 13/142,169

(22) PCT Filed: Dec. 25, 2009
(86) PCT No.: PCT/JP2009/071643

§ 371 Date: Jun. 24, 2011

(30) Foreign Application Priority Data
Dec. 25, 2008 (JP) 2008-331607

(51) Int. Cl. H04W 72/08; H04W 24/02; H04J 4/00

(52) U.S. Cl. 370/330; 370/329

(57) ABSTRACT

A radio communication system including a threshold setting unit, which sets a channel assignment threshold for each respective communication channel thereupon, and a threshold setting unit, which sets a channel assignment threshold for each respective communication channel thereupon, for carrier sensing. The threshold setting unit employs a first random number, which is generated, based on an unique value of a radio base station, on a per communication channel basis, to set a first channel assignment threshold on the per communication channel basis. The threshold setting unit employs a second random number, which is generated, based on an unique value of a radio base station, on a per communication channel basis, to set a second channel assignment threshold on the per communication channel basis.

### TECHNICAL FIELD

The present invention relates to a radio communication system, a radio base station, and a threshold setting method for assigning a radio terminal at least one communication channel having an interference level lower than a channel assignment threshold among multiple communication channels.

### BACKGROUND ART

A conventional radio base station which performs channel assignment in an autonomous and distributed manner performs an unused channel assessment called carrier sensing. Specifically, the radio base station measures interference levels of multiple communication channels, and determines as an unused channel a low interference communication channel which has the measured interference level lower than a channel assignment threshold. In such a radio communication system, the radio base station assigns the low interference communication channel to a radio terminal by use of carrier sensing. In this respect, it is general that the channel assignment threshold used in the carrier sensing is set at the same value for radio base stations and communication channels.

Meanwhile, an attention has been focused in recent years on a wideband radio communication scheme employing a multi-carrier radio communication scheme such as the Orthogonal Frequency Division Multiple Access (OFDMA) in order to efficiently utilize limited frequency resources (see Patent Literature 1, for example). The multi-carrier radio communication scheme is capable of assigning multiple communication channels called sub-channels to a single radio terminal. The radio base station and the radio terminal are capable of increasing the communication capacity in a radio communication as they have amore number of communication channels for use in the radio communication.

### PRIOR ART DOCUMENT

### Patent Document

Patent Document 1: Japanese Patent Application Publication No. 2003-169036

### SUMMARY OF THE INVENTION

In the multi-carrier radio communication scheme employing the OFDMA scheme, one radio terminal uses a wide frequency band for its communication. For this reason, when a radio base station performs channel assignment to a radio terminal by using carrier sensing, a large number of communication channels may be assigned to the radio terminal. In this case, the following problems occur.

Specifically, if a first radio base station assigns a large number of communication channels to a first radio terminal under the control of the first radio base station, a less number of communication channels are determined as unused channels by carrier sensing of a second radio base station which is located around the first radio base station. Thus, a less number of communication channels are assignable to a second radio terminal under the control of the second radio base station. This involves problems that the communication capacity and the communication quality in the second radio base station are not guaranteed and that fairness between the first radio base station and the second radio base station is not achieved.

In view of the above, an objective of the present invention is to provide a radio communication system, a radio base station, and a threshold setting method which make it possible to assign multiple communication channels to a radio terminal, and which also make it possible to guarantee the communication capacity and the communication quality in each of radio base stations and to achieve fairness between the radio base stations, when channel assignment is performed by use of carrier sensing.

In order to solve the problems described above, the present invention has the following features. First of all, according to a first feature of the present invention, there is provided a radio communication system (radio communication system 10) comprising: a first radio base station (radio base station 1A) configured to assign a first radio terminal (e.g. radio terminal 2A) a first low interference communication channel having an interference level lower than a channel assignment threshold among a plurality of communication channels within a predetermined frequency band; and a second radio base station (radio base station 1B) configured to assign a second radio terminal a second low interference communication channel having an interference level lower than a channel assignment threshold among the plurality of communication channels within the predetermined frequency band, wherein a first channel assignment threshold which is the channel assignment threshold for determining the first low interference communication channel is different from a second channel assignment threshold which is the channel assignment threshold for determining the second low interference communication channel.

A second feature of the present invention relates to the first feature of the present invention, and is summarized as follows. The radio communication system further comprises: a first threshold setting unit (threshold setting unit 122A) configured to set the first channel assignment threshold; and a second threshold setting unit (threshold setting unit 122B) configured to set the second channel assignment threshold, wherein the first threshold setting unit sets the channel assignment threshold for each of the communication channels by use of a first random number generated on the basis of a value unique to the first radio base station, and the second threshold setting unit sets the channel assignment threshold for each of the communication channels by use of a second random number generated on the basis of a value unique to the second radio base station. According to the radio communication system, the first threshold setting unit sets the first channel assignment threshold to each communication channel. This setting defines a communication channel having a high assigned priority and a communication channel having a low assigned priority.

Likewise, the second threshold setting unit sets the second channel assignment threshold to each communication channel. This setting defines a communication channel having a high assigned priority and a communication channel having a low assigned priority.

Furthermore, the first threshold setting unit uses the first random number generated for each communication channel on the basis of a value unique to the first radio base station, while the second threshold setting unit uses the second random number generated for each communication channel on the basis of a value unique to the second radio base station. For this reason, priorities given to communication channels differ between the first radio base station and the second radio base station.

Accordingly, it is possible to make a communication channel having a high assigned priority less likely to interfere with a communication channel having a low assigned priority, as well as to make a communication channel having a high assigned priority less likely to interfere with a communication channel having a low assigned priority. Thus, each radio base station can secure an assignable communication channel in preference to other radio base stations. For this reason, it is possible to guarantee the communication capacity and the communication quality in each of the radio base stations and to achieve fairness between the radio base stations.

A third feature of the present invention relates to the second feature of the present invention, and is summarized as follows. The first threshold setting unit multiplies the first random number generated for each of the communication channels by a predetermined coefficient (coefficient α) for adjusting a difference between the first channel assignment thresholds, adds a result of multiplying the first random number by the predetermined coefficient and a reference value serving as a reference for the channel assignment threshold, and sets a result of the addition as the first channel assignment threshold for the communication channel, and the second threshold setting unit multiplies the second random number generated for each of the communication channels by the predetermined coefficient, adds a result of multiplying the second random number by the predetermined coefficient and the reference value, and sets a result of the addition as the second channel assignment threshold for the communication channel.

A fourth feature of the present invention relates to the second feature or the third feature of the present invention, and is summarized as follows. The first threshold setting unit is provided in the first radio base station, and the second threshold setting unit is provided in the second radio base station.

A fifth feature of the present invention relates to the second feature or the third feature of the present invention, and is summarized as follows. The radio communication system further comprises a server device (server 4) configured to manage the first radio base station and the second radio base station, wherein the first threshold setting unit and the second threshold setting unit are provided in the server device.

A sixth feature of the present invention relates to any one of the first to fifth features of the present invention, and is summarized as follows. The communication channels are configured in accordance with an orthogonal frequency division multiple access scheme and a time division multiple access scheme.

A seventh feature of the present invention relates to the sixth features of the present invention, and is summarized as follows. The first threshold setting unit sets the first channel assignment threshold for each of the communication channels by use of the first random number generated for the communication channel on the basis of a subchannel number and a time slot number in addition to the value unique to the first radio base station, the subchannel number determined according to the orthogonal frequency division multiple access scheme, the time slot number determined according to the time division multiple access scheme, and the second threshold setting unit sets the second channel assignment threshold for each of the communication channels by use of the second random number generated for the communication channel on the basis of the subchannel number and the time slot number in addition to the value unique to the second radio base station.

According to an eighth feature of the present invention, there is provided a radio base station (radio base station 1A) configured to measure interference levels of a plurality of communication channels and to assign a radio terminal (e.g. radio terminal 2A) at least one low interference communication channel having the measured interference level lower than a channel assignment threshold, the radio base station comprising a threshold setting unit (threshold setting unit 122A) configured to set the channel assignment threshold for each of the communication channels, wherein the threshold setting unit sets the channel assignment threshold for each of the communication channels on the basis of a value unique to the radio base station.

According to a ninth feature of the present invention, there is provided a method comprising the steps of: assigning, by a first radio base station, a first radio terminal a first low interference communication channel having an interference level lower than a channel assignment threshold among a plurality of communication channels within a predetermined frequency band; and assigning, by a second radio base station, a second radio terminal a second low interference communication channel having an interference level lower than a channel assignment threshold among the plurality of communication channels located within the predetermined frequency band, wherein a first channel assignment threshold which is the channel assignment threshold for determining the first low interference communication channel is different from a second channel assignment threshold which is the channel assignment threshold for determining the second low interference communication channel.

The present invention can provide a radio communication system, a radio base station, and a threshold setting method which make it possible to assign multiple communication channels to a radio terminal, and which also make it possible, when channel assignment is performed by use of carrier sensing, to guarantee the communication capacity and the communication quality in each of radio base stations and to achieve fairness between the radio base stations.

### BRIEF DESCRIPTION OF THE DRAWINGS

FIG. 1 is a schematic configuration diagram of an entire radio communication system according to an embodiment of the present invention.

FIG. 2 is a functional block diagram illustrating configurations of radio base stations according to the embodiment of the present invention.

FIG. 3 is a diagram illustrating a channel assignment state when a channel assignment threshold is set at a constant value according to a comparative example for the embodiment of the present invention.

FIG. 4 is a diagram illustrating an example of a channel assignment state in the radio communication system according to the embodiment of the present invention.

FIG. 5 is a flowchart illustrating details of an operation in the radio base station, specifically, details of a method for setting a channel assignment threshold according to the embodiment of the present invention.

FIG. 6 is a schematic configuration diagram of an entire radio communication system according to another embodiment.

### DESCRIPTION OF EMBODIMENTS

Next, with reference to the drawings, embodiments of the present invention will be described. Specifically, (1) Schematic Configuration of Entire Radio Communication System, (2) Configuration of Radio Base Station, (3) General Operation of Radio Base Station, (4) Details of Operation of Radio Base Station, (5) Operation and Effect, and (6) Other Embodiment will be described. Note that, in the following description of the drawings, same or similar reference signs denote same or similar elements and portions.

### (1) Schematic Configuration of Entire Radio Communication System

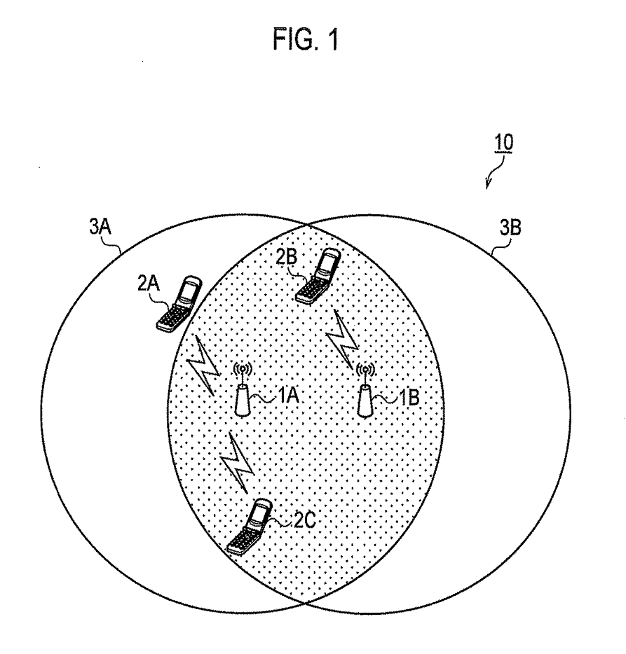

FIG. 1 is a schematic configuration diagram of an entire radio communication system 10 according to an embodiment.

The embodiment is made on the assumption that the radio communication system 10 has a configuration based on a next-generation PHS (Personal Handyphone System). The radio communication system 10 adopts the Orthogonal Frequency Division Multiple Access (OFDMA) scheme and the Time Division Multiple Access (TDMA) scheme as a multiplexing scheme, and adopts the Time Division Duplex (TDD) scheme as a duplex scheme.

In the example in FIG. 1, the radio communication system 10 includes a radio base station 1A, a radio base station 1B, a radio terminal 2A, a radio terminal 2B, and a radio terminal 2C.

In response to an assignment request from a radio terminal 2A located in a cell (microcell) 3A of a radio base station 1A, the radio base station 1A assigns a communication channel to the radio terminal 2A, and performs a radio communication with the radio terminal 2A by use of the assigned communication channel In the same manner, the radio base station 1A assigns a communication channel to a radio terminal 2C and performs a radio communication with the radio terminal 2C by use of the assigned communication channel.

A radio base station 1B assigns a communication channel to a radio terminal 2B located in a cell (microcell) 3B of the radio base station 1B, and performs a radio communication with the radio terminal 28 by use of the assigned communication channel.

The radio base station 1A is capable of assigning multiple communication channels to each of the radio terminal 2A and the radio terminal 2C, and of dynamically changing the assigned communication channels. The radio base station 1B is capable of assigning multiple communication channels to the radio terminal 2B, and of dynamically changing the assigned communication channels.

In the radio communication system 10, according to the OFDMA scheme, the entire frequency band in the radio communication system 10 is frequency-divided into a subchannels. In addition, according to the TDMA scheme, a part of one frame period for the reverse link and the other part of the one frame period for the forward link of the radio communication system 10 are each time-divided into b time slots.

Thus, a×b communication channels are configured in each of the reverse and forward links. Each of the communication channels thus configured is made on the basis of one time slot and one subchannel, and is called a physical resource unit (PRU) in the next-generation PHS.

The radio base station 1A and the radio base station 1B perform the channel assignment in an autonomous distributed manner. Specifically, the radio base station 1A detects radio signals transmitted and received by the radio base station 1B, determines a communication channel which is currently being assigned by the radio base station 1B, and assigns a communication channel, which is not yet assigned by the radio base station 1B, to the radio terminal 2A or the radio terminal 2C. Likewise, the radio base station 1B detects radio signals transmitted and received by the radio base station 1A, determines a communication channel which is currently being assigned by the radio base station 1A, and assigns the radio terminal 2B a communication channel not yet assigned by the radio base station 1A. Such processing is called carrier sensing as described above. With this processing, the radio base station 1A and the radio base station 1B autonomously prevent the interference between each other.

The radio base station 1A assigns the radio terminal 2A a communication channel among the a×b communication channels, the assigned communication channel having a level of interference by an interfering source (e.g., radio base station 1B and radio terminal 2B) lower than a channel assignment threshold. Specifically, in the embodiment, the radio base station 1A configures a first radio base station which measures multiple communication channels for their interference levels and assigns a first radio terminal (radio terminal 2A or radio terminal 2C) at least one first low interference communication channel having the measured interference level lower than a first channel assignment threshold.

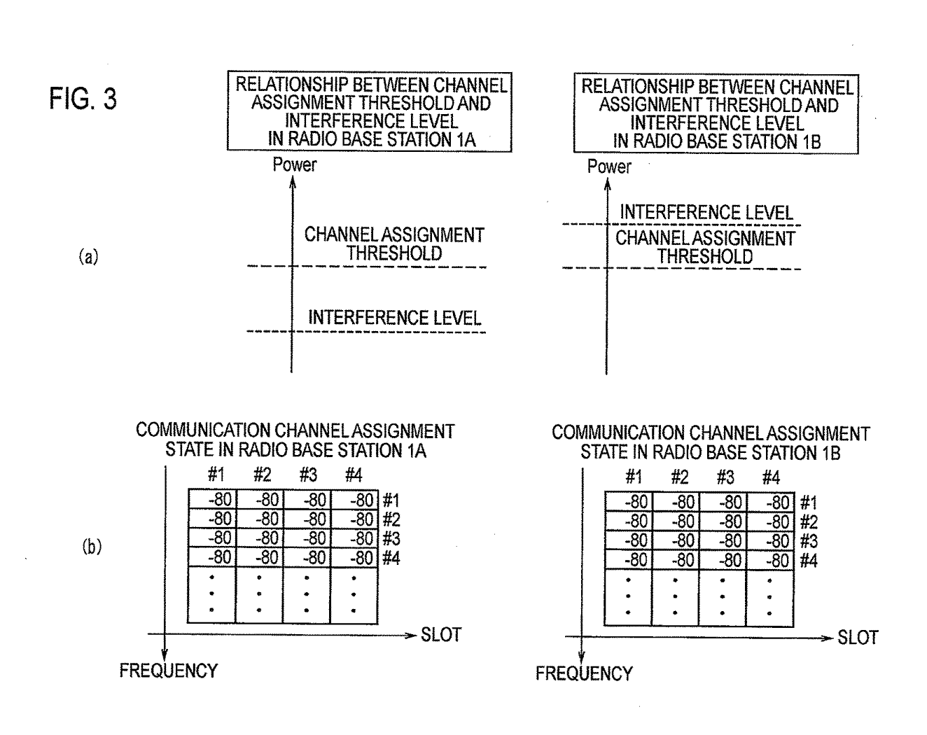

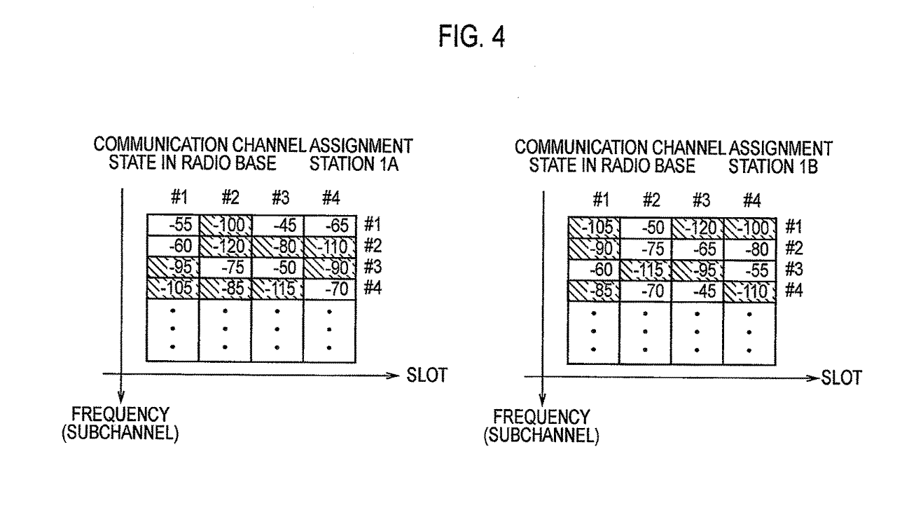

Meanwhile, the radio base station 1B assigns the radio terminal 2A a communication channel among the a×b communication channels, the assigned communication channel having a level of interference by an interfering source (e.g., radio base station 1A, radio terminal 2A, and radio terminal 2C) lower than a channel assignment threshold. In the embodiment, the radio base station 1B configures a second radio base station which measures multiple communication channels for their interference levels and assigns a second radio terminal (radio terminal 2B) at least one second low interference communication channel having the measured interference level lower than a second channel assignment threshold. Here, the multiple communication channels each have a predetermined frequency band (see FIG. 3 and FIG. 4).

Specifically, when a result of the carrier sensing of a communication channel specified by a given subchannel and a given time slot shows that its interference level is equal to or lower than a channel assignment threshold, the radio base station 1B assigns the communication channel to the radio terminal 2B. Thus, the radio terminal 2B performs a voice communication or a data communication by use of the assigned communication channel.

Thereafter, the radio base station 1B performs carrier sensing also when other radio terminals are to perform communications. In this case, however, a result of the carrier sensing of a communication channel which is currently being assigned by the radio base station 1A shows that its interference level exceeds the channel assignment threshold. For this reason, the radio base station 1B assigns a communication channel, among communication channels specified by other subchannels and other time slots, which has its interference level equal to or lower than the channel assignment threshold as a result of the carrier sensing.

In a wideband radio communication system, particularly, each radio terminal can use a very wide frequency band. For this reason, a communication channel designated by the radio base station 1A and a communication channel designated by the radio base station 1B are highly likely to collide with each other. If the radio base station 1A occupies a frequency band and a communication time zone, the radio base station 1B is not allowed to perform communication therein. On the other hand, if the radio base station 1B occupies a frequency band and a communication time zone, the radio base station 1A is not allowed to perform communication therein.

In the embodiment, channel assignment thresholds are optimally set respectively for the radio base station 1A and the radio base station 1B. This achieves ensuring the lower limit value of the communication capacity in each radio base station and each radio terminal, ensuring QoS in each radio base station and each radio terminal, and ensuring fairness between radio base stations and radio terminals.

### (2) Configuration of Radio Base Station

Next, (2.1) Configuration of Radio Base Station 1A and (2.2) Configuration of Radio Base Station 1B will be described.

### (2.1) Configuration of Radio Base Station 1A

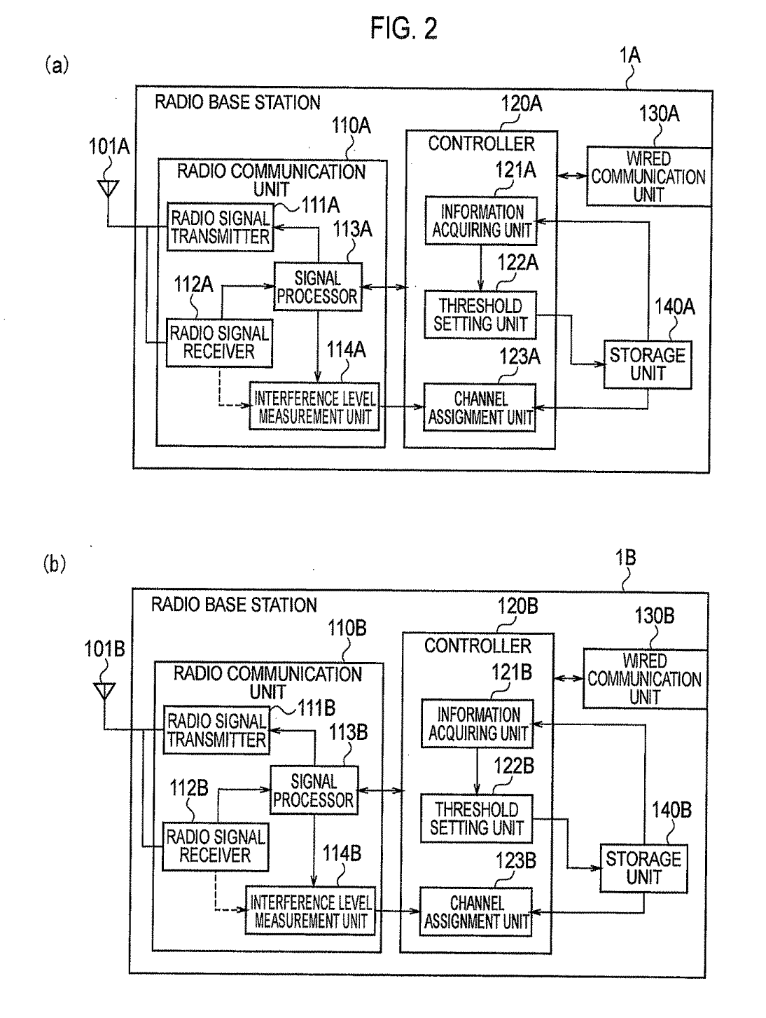

FIG. 2(a) is a functional block diagram illustrating a configuration of the radio base station 1A. As illustrated in FIG. 2(a), the radio base station 1A includes an antenna unit 101A, a radio communication unit 110A, a controller 120A, a wired communication unit 130A, and a storage unit 140A.

The radio communication unit 110A exchanges radio signals with the radio terminal 2A or the radio terminal 2C via the antenna unit 101A. In this respect, the antenna unit 101A may be an adaptive array antenna formed of multiple antennas. The controller 120A is formed of a CPU, for example, and controls various functions included in the radio base station 1A. The storage unit 140A is formed of a memory, for example, and stores various pieces of information for use in control by the radio base station 1A and for other purposes. The wired communication unit 130A functions as an interface with a wired communication network.

The radio communication unit 110A includes a radio signal transmitter 111A, a radio signal receiver 112A, a signal processor 113A, and an interference level measurement unit 114A.

The signal processor 113A codes data to be transmitted to the radio terminal 2A or the radio terminal 2C and modulates the coded data. The signal processor 113A performs the serial/parallel conversion and the inverse fast Fourier transform (IFFT) on the modulated data. OFDM signals generated through this processing are inputted into the radio signal transmitter 111A. The radio signal transmitter 111A includes a power amplifier, an up-converter, and the like. The radio signal transmitter 111A converts the inputted OFDM signals into radio signals, and then transmits the radio signals to the radio terminal 2A or the radio terminal 2C.

The radio signal receiver 112A includes a low-noise amplifier, a down-converter, and the like. The radio signal receiver 112A converts radio signals received from the radio terminal 2A into OFDM signals, and then inputs the OFDM signals to the signal processor 113A. The signal processor 113A performs the fast Fourier transform (FFT) and the parallel/serial conversion on the OFDM signals and then demodulates and decodes the signals.

The interference level measurement unit 114A measures received power of radio signals received from the interfering source (e.g., radio base station 1B and radio terminal 2B) as an interference level. Specifically, the interference level measurement unit 114A measures each of the a×b communication channels for its interference level.

The controller 120A includes an information acquiring unit 121A, a threshold setting unit 122A, and a channel assignment unit 123A.

The information acquiring unit 121A acquires, from the storage unit 140A, various pieces of information for use in setting a first channel assignment threshold. In the embodiment, the information acquiring unit 121A acquires a value unique to the radio base station 1A, subchannel numbers for identifying subchannels, and time slot numbers for identifying time slots. Here, a base station identifier (BSID) for identifying the radio base station 1A, a serial number of the radio base station 1A, or the like can be used as the value unique to the radio base station 1A. Hereinbelow, an example where the BSID is used as the value unique to the radio base station 1A will be described.

The threshold setting unit 122A configures a first threshold setting unit which sets a first channel assignment threshold for each of the a×b communication channels on the basis of the information acquired by the information acquiring unit 121A. The threshold setting unit 122A generates a random number (first random number, hereinbelow) for each communication channel on the basis of the BSID and then sets a first channel assignment threshold for each communication channel.

For example, the threshold setting unit 122A uses sets, each including a BSID, a subchannel number, and a slot number, as initial values for a random code (PN code), and obtains a first channel assignment threshold individually for each set of a BSID, a subchannel number, and a slot number. The details of a method of setting the first channel assignment thresholds will be described later. The first channel assignment thresholds set by the threshold setting unit 122A are stored into the storage unit 140A. In this respect, the setting of the first channel assignment thresholds is performed at the time, for example, of installing the radio base station 1A.

The channel assignment unit 123A has a function to assign a communication channel to the radio terminal 2A or the radio terminal 2C, a function to manage information on the assigned communication channel (hereinafter referred to as assignment information), and a function to release the assigned communication channel.

The channel assignment unit 123A compares the first channel assignment thresholds and the interference levels of the communication channels measured by the interference level measurement unit 114A, and thus specifies the first low interference communication channel which has its interference level lower than the corresponding one of the first channel assignment thresholds. In this event, the channel assignment unit 123A acquires the corresponding one of the first channel assignment thresholds for each communication channel from the storage unit 140A, and uses the acquired first channel assignment threshold for comparison with the interference level. Thereafter, the channel assignment unit 123A assigns the specified first low interference communication channel to the radio terminal 2A or the radio terminal 2C.

### (2.2) Configuration of Radio Base Station 1B

FIG. 2B is a functional block diagram illustrating a configuration of the radio base station 1B. Here, the description on the same components as those of the radio base station 1B will be omitted.

The radio base station 1B includes an antenna unit 101B, a radio communication unit 110B, a controller 120B, a wired communication unit 130B, and a storage unit 140B. The radio communication unit 110B includes a radio signal transmitter 111B, a radio signal receiver 112B, a signal processor 113B, and an interference level measurement unit 114B. The controller 120B includes an information acquiring unit 121B, a threshold setting unit 122B, and a channel assignment unit 123B.

The interference level measurement unit 114B measures received power of radio signals received from an interfering source (e.g., radio base station 1A, radio terminal 2A, and radio terminal 2C) as an interference level. Specifically, the interference level measurement unit 114B measures each of the a×b communication channels for its interference level.

The information acquiring unit 121B the information acquiring unit 121B acquires a value unique to the radio base station 1B (BSID, here), subchannel numbers for identifying subchannels, and time slot numbers for identifying time slots.

The threshold setting unit 122B configures a second threshold setting unit which sets a second channel assignment threshold for each of the a×b communication channels on the basis of the information acquired by the information acquiring unit 121B. The threshold setting unit 122B generates a random number (second random number, hereinbelow) for each communication channel on the basis of the BSID and then sets a second channel assignment threshold for each communication channel. The second channel assignment thresholds set by the threshold setting unit 122B are stored into the storage unit 140B. In this respect, the setting of the second channel assignment thresholds is executed at the time, for example, of installing the radio base station 1B.

The channel assignment unit 123B has a function to assign a communication channel to the radio terminal 2B, a function to manage assignment information on the assigned communication channel, and a function to release the assigned communication channel. The channel assignment unit 123B compares, with the second channel assignment thresholds, the interference levels of the communication channels measured by the interference level measurement unit 114B, and thus specifies the low interference communication channel which has its interference level lower than the corresponding second channel assignment threshold. In this event, the channel assignment unit 123B acquires the corresponding one of the second channel assignment thresholds for each communication channel from the storage unit 140B, and uses the acquired second channel assignment threshold for use in comparison with the interference level. Thereafter, the channel assignment unit 123B assigns the specified second low interference communication channel to the radio terminal 2B.

### (3) General Operation of Radio Base Station

Next, by use of FIG. 3 and FIG. 4, general operations of the radio base station 1A and the radio base station 1B will be described.

FIG. 3 is a diagram illustrating a relationship between a channel assignment threshold and an interference level when the channel assignment threshold is set at a constant value according to a comparative example for the embodiment.

In the example of FIG. 3, it is assumed that the channel assignment threshold is set to −80 dBm for all the communication channels that the radio base station 1A can designate and all the communication channels that the radio base station 1B can designate, and that the radio base station 1A has assigned all the communication channels to the radio terminal 2A and the radio terminal 2C. In other words, the radio base station 1A occupies the frequency band and the communication time zone. In this circumstance, the radio base station 1B cannot assign any communication channel to the radio terminal 2B since the interference levels in all the communication channels exceed the channel assignment threshold.

FIG. 4 is a diagram illustrating a channel assignment state in the radio base station 1A and the radio base station 1B according to the embodiment, where various channel assignment thresholds are set. Herein, communication channels which are not yet assigned are expressed by shading.

In the example of FIG. 4, first channel assignment thresholds are set at different values, within a range from a minimum of −120 dBm to a maximum of −45 dBm, respectively for communication channels, and channel assignment thresholds are set at different values within the range respectively for second communication channels. Moreover, communication channels for which high first channel assignment thresholds are set and communication channels for which high second channel assignment thresholds are set are currently being assigned.

For example, a first channel assignment threshold for a communication channel specified by the subchannel number 1 and the time slot number 1 is −55 dBm, which is high, and is thus currently being assigned. Meanwhile, a second channel assignment threshold for a communication channel specified by the subchannel number 1 and the time slot number 1 is −105 dBm, which is low, and thus is not yet assigned.

A first channel assignment threshold for a communication channel specified by the subchannel number 1 and the time slot number 2 is −100 dBm, which is low, and is not yet assigned. Meanwhile, a second channel assignment threshold for a communication channel specified by the subchannel number 1 and the time slot number 2 is −50 dBm, which is high, and thus is currently being assigned.

As has been described, in the example of FIG. 4, among the communication channels which are specified by the same subchannel and the same time slot, a channel assignment threshold for one of the communication channels is set to be high, and a channel assignment threshold for the other one of the communication channels is set to be low. As the higher channel assignment threshold is set for a communication channel, the communication channel has a higher assigned priority, since the interference level thereof is more likely to be lower than the channel assignment threshold.

In other words, communication channels which are given different priorities are defined for each radio base station by setting random channel assignment thresholds respectively for sets each including a subchannel and a time slot, and by setting the random assignment thresholds in such a manner that the randomness differs between neighboring base stations.

As a result, each radio base station is configured to assign communication channels in order from one having a higher priority, and thus a communication channel having a low priority is less likely to be used, on the other hand. Accordingly, it is possible to make each radio base station less likely to occupy a frequency band and a communication time zone. Moreover, even in a case where the numbers of radio terminals contained by radio base stations differ between radio base stations in an imbalanced manner, communication channels are assigned almost equally between the radio base stations.

### (4) Details of Operation of Radio Base Station

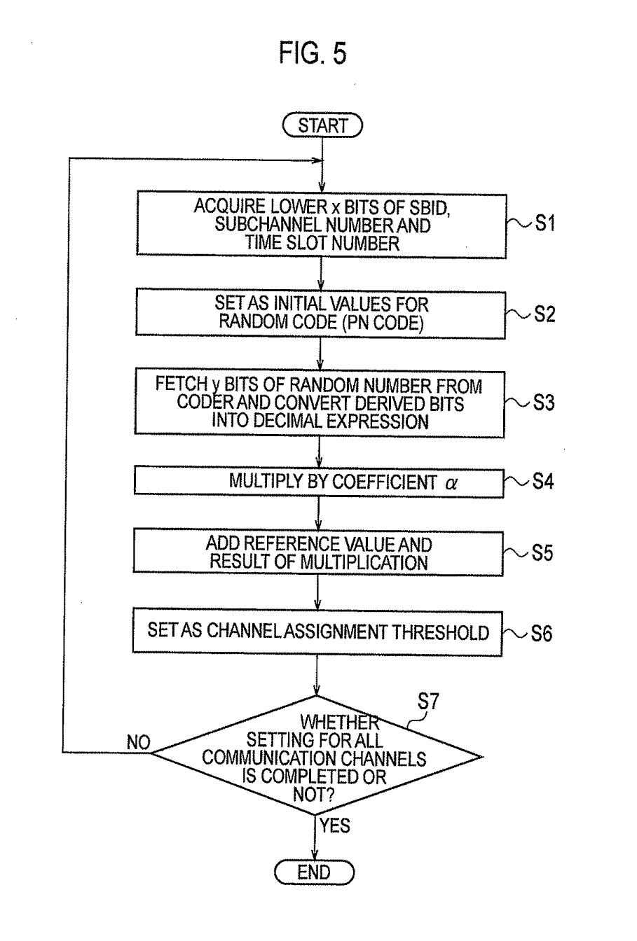

FIG. 5 is a flowchart illustrating details of an operation in the radio base station 1A, specifically, details of a method of setting the first channel assignment threshold. The processing flow illustrated in FIG. 5 is performed also by the radio base station 1B.

In Steps S1 to S6, a first channel assignment threshold is set for one communication channel which is a threshold setting target.

Firstly, in Step S1, the information acquiring unit 121A acquires information pieces including lower x bits of the BSID of the radio base station 1A, and the subchannel number and the time slot number of the communication channel of the threshold setting target.

In Step S2, the threshold setting unit 122A sets the information pieces acquired by the information acquiring unit 121A in Step S1, as initial values for a random code. Note that the threshold setting unit 122A has a coder (or arithmetic algorithm) incorporated therein, the coder generating a random code.

In Step S3, the threshold setting unit 122A fetches y bits of a random number (first random number) from the coder and converts the derived bits into a decimal expression.

In Step S4, the threshold setting unit 122A multiplies the first random number converted into the decimal expression in Step S3, by a coefficient α. The coefficient α is used to adjust a difference between the first channel assignment thresholds allocated to the respective communication channels. The coefficient α is empirically determined through simulations and the like. In the example of FIG. 4, the difference between the first channel assignment thresholds is set to 5 dB on the basis of the coefficient α.

In Step S5, the threshold setting unit 122A adds a reference value and a result of multiplying the first random number obtained in Step S4 by the coefficient α, the reference value serving as a reference for the first channel assignment threshold.

In Step S6, the threshold setting unit 122A sets the result of addition obtained in Step S5 as the first channel assignment threshold for the communication channel of the threshold setting target.

In Step S7, the threshold setting unit 122A judges whether setting of first channel assignment thresholds for all the communication channels is completed or not. If there is still a communication channel for which a first channel assignment threshold is not set, the processing returns to Step S1 and processing for setting a threshold for a communication channel of the next threshold setting target will be performed.

### (5) Operation and Effect

As has been described above, according to the radio communication system 10, the threshold setting unit 122A sets the first channel assignment threshold for each communication channel. This setting defines a communication channel having a high assigned priority and a communication channel having a low assigned priority. Likewise, the threshold setting unit 122B sets the second channel assignment threshold for each communication channel. This setting defines a communication channel having a high assigned priority and a communication channel having a low assigned priority.

Furthermore, the threshold setting unit 122A uses a first random number generated for each communication channel on the basis of a value unique to the radio base station 1A, while the threshold setting unit 122B uses a second random number generated for each communication channel on the basis of a value unique to the radio base station 1B. For this reason, priorities given to communication channels differ between the radio base station 1A and the radio base station 1B.

Accordingly, it is possible to make a communication channel having a high assigned priority less likely to interfere with a communication channel having a low assigned priority, as well as to make a communication channel having a high assigned priority less likely to interfere with a communication channel having a low assigned priority. Thus, each radio base station can secure an assignable communication channel in preference to other radio base stations. For this reason, it is possible to guarantee the communication capacity and the communication quality in each of the radio base stations and to achieve fairness between the radio base stations.

In the embodiment, the threshold setting unit 122A multiplies the first random number generated for each communication channel by a coefficient α for adjusting the difference between the channel assignment thresholds, adds a reference value serving as a reference of each channel assignment threshold and a result of multiplying the first random number by the coefficient α, and then sets the result of addition as a channel assignment threshold for a first communication channel. The use of the coefficient α makes it possible to adjust the difference between the channel assignment thresholds and also makes it possible to determine a pitch at which the priorities are to be set. Moreover, the use of the reference value makes it possible to set the channel assignment thresholds at practically appropriate values.

In the embodiment, the threshold setting unit 122A sets the first channel assignment threshold for each communication channel by use of the first random number generated for the communication channel on the basis of a value unique to the radio base station 1A, and the subchannel number and the time slot number of the communication channel. The threshold setting unit 122B sets the second channel assignment threshold for each communication channel by use of the second random number generated for the communication channel on the basis of a value unique to the radio base station 1B, and the subchannel number and the time slot number of the communication channel. The use of the subchannel numbers and the time slot numbers for generating the random numbers can reliably make the channel assignment thresholds for the communication channels different from one another.

### (6) Other Embodiments

As described above, the details of the present invention have been disclosed by using the embodiment of the present invention. However, it should not be understood that the description and drawings which constitute part of this disclosure limit the present invention. From this disclosure, various alternative embodiments, examples, and operation techniques will be easily found by those skilled in the art.

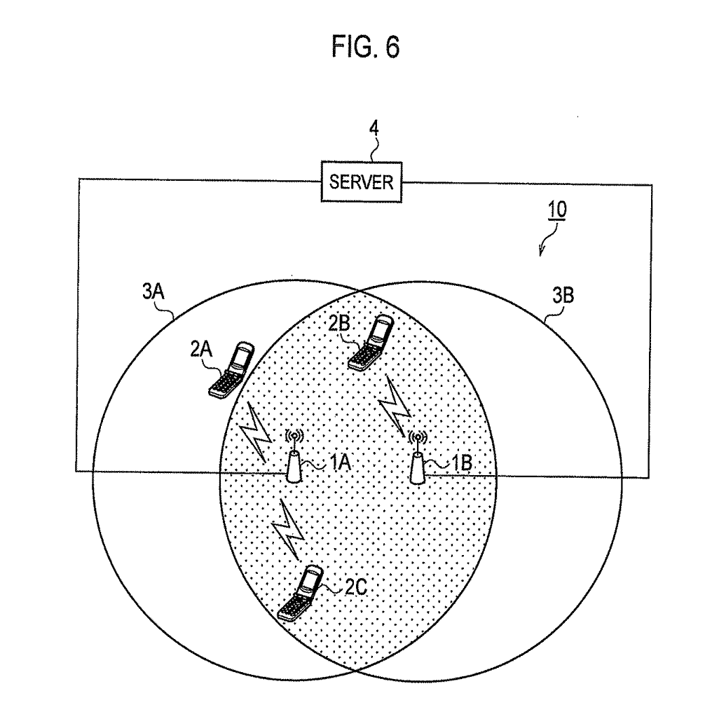

In the embodiment described above, the threshold setting unit 122A is provided in the radio base station 1A, and the threshold setting unit 122B is provided in the radio base station 1B. However, it is also possible to provide the threshold setting unit 122A and the threshold setting unit 122B in other devices. For example, the threshold setting unit 122A and the threshold setting unit 122B may be provided in a server 4 (server device) as illustrated in FIG. 6. The server 4 is connected to the radio base station 1A and the radio base station 1B via a wired communication network, and manages the radio base station 1A and the radio base station 1B.

In the embodiment described above, an example of a case where the channel assignment threshold is set through the processing flow illustrated in FIG. 5. If, however, the result obtained in Step S3 is preferable to some extent, the processing of Steps S4 and S5 may be omitted.

Furthermore, although the subchannel numbers and the time slot numbers are used for generating the random numbers, the generation of the random numbers is not limited to the use thereof. The channel assignment thresholds may be set by generating the random numbers by use of only the BSID, and then by arranging the random numbers in a different order by use of the subchannel numbers and the time slot numbers.

In the embodiment described above, the radio communication system 10 has a configuration based on the next-generation PHS. The present invention, however, is applicable not only to the next-generation PHS, but also to any radio communication system employing the CSMA/CD (Carrier Sense Multiple Access/Collision Detection) scheme or the CSMA/CA (Carrier Sense Multiple Access/Collision Avoidance) scheme which are schemes performing the carrier sensing. The present invention may be applied, for example, to the wireless LAN (IEEE802.11) scheme, or to the conventional type of PHS. Furthermore, the present invention is also applicable, in the same manner, to a radio communication system employing LTE (Long Term Evolution) which is the standard developed by 3GPP (Third Generation Partnership Project).

As described above, the present invention naturally includes various embodiments which are not described herein. Accordingly, the technical scope of the present invention should be determined only by the matters to define the invention in the scope of claims regarded as appropriate based on the description.

Note that the entire content of Japanese Patent Application No. 2008-331607 (filed on Dec. 25, 2008) is incorporated herein by reference.

### INDUSTRIAL APPLICABILITY

As has been described above, the radio communication system, the radio base station, and the threshold setting method according to the present invention make it possible to assign multiple communication channels to a radio terminal, and also make it possible to guarantee the communication capacity and the communication quality in each of radio base stations and to achieve fairness between the radio base stations when channel assignment is performed by use of carrier sensing. Thus, the radio communication system, the radio base station, and the threshold setting method according to the present invention are useful as a communication system and the like.

1. A radio communication system comprising:
a first radio base station configured to assign a first radio terminal a first low interference communication channel having an interference level lower than a channel assignment threshold among a plurality of communication channels within a predetermined frequency band; and
a second radio base station configured to assign a second radio terminal a second low interference communication channel having an interference level lower than a channel assignment threshold among the plurality of communication channels within the predetermined frequency band, wherein
a first channel assignment threshold which is the channel assignment threshold for determining the first low interference communication channel is different from a second channel assignment threshold which is the channel assignment threshold for determining the second low interference communication channel.

2. The radio communication system according to claim 1, further comprising:
a first threshold setting unit configured to set the first channel assignment threshold; and
a second threshold setting unit configured to set the second channel assignment threshold, wherein
the first threshold setting unit sets the first channel assignment threshold for each of the communication channels by use of a first random number generated on the basis of a value unique to the first radio base station, and
the second threshold setting unit sets the second channel assignment threshold for each of the communication channels by use of a second random number generated on the basis of a value unique to the second radio base station.

3. The radio communication system according to claim 2, wherein
the first threshold setting unit multiplies the first random number generated for each of the communication channels by a predetermined coefficient for adjusting a difference between the first channel assignment thresholds, adds a result of multiplying the first random number by the predetermined coefficient and a reference value serving as a reference for the channel assignment threshold, and sets a result of the addition as the first channel assignment threshold for the communication channel, and
the second threshold setting unit multiplies the second random number generated for each of the communication channels by the predetermined coefficient, adds a result of multiplying the second random number by the predetermined coefficient and the reference value, and sets a result of the addition as the second channel assignment threshold for the communication channel.

4. The radio communication system according to claim 2, wherein
the first threshold setting unit is provided in the first radio base station, and
the second threshold setting unit is provided in the second radio base station.

5. The radio communication system according to claim 2, further comprising
a server device configured to manage the first radio base station and the second radio base station, wherein
the first threshold setting unit and the second threshold setting unit are provided in the server device.

6. The radio communication system according to claim 1, wherein the communication channels are configured in accordance with an orthogonal frequency division multiple access scheme and a time division multiple access scheme.

7. The radio communication system according to claim 6, wherein
the first threshold setting unit sets the first channel assignment threshold for each of the communication channels by use of the first random number generated for the communication channel on the basis of a subchannel number and a time slot number in addition to the value unique to the first radio base station, the subchannel number determined according to the orthogonal frequency division multiple access scheme, the time slot number determined according to the time division multiple access scheme, and
the second threshold setting unit sets the second channel assignment threshold for each of the communication channels by use of the second random number generated for the communication channel on the basis of the subchannel number and the time slot number in addition to the value unique to the second radio base station.

8. A radio base station configured to measure interference levels of a plurality of communication channels and to assign a radio terminal at least one low interference communication channel having the measured interference level lower than a channel assignment threshold, the radio base station comprising
a threshold setting unit configured to set the channel assignment threshold for each of the communication channels, wherein
the threshold setting unit sets the channel assignment threshold for each of the communication channels on the basis of a value unique to the radio base station.

9. A threshold setting method for setting channel assignment thresholds, comprising the steps of:
assigning, by a first radio base station, a first radio terminal a first low interference communication channel having an interference level lower than a channel assignment threshold among a plurality of communication channels within a predetermined frequency band; and
assigning, by a second radio base station, a second radio terminal a second low interference communication channel having an interference level lower than a channel assignment threshold among the plurality of communication channels located within the predetermined frequency band, wherein
a first channel assignment threshold which is the channel assignment threshold for determining the first low interference communication channel is different from a second channel assignment threshold which is the channel assignment threshold for determining the second low interference communication channel.

10. The radio communication system according to claim 3, wherein
the first threshold setting unit is provided in the first radio base station, and
the second threshold setting unit is provided in the second radio base station.

11. The radio communication system according to claim 3, further comprising
a server device configured to manage the first radio base station and the second radio base station, wherein
the first threshold setting unit and the second threshold setting unit are provided in the server device.
